(19) United States
(12) Patent Application Publication
(10) Pub. No.: US 2011/0095552 A1
(43) Pub. Date: Apr. 28, 2011

(54) GRASPING SYSTEM

(76) Inventor: Billy Todd Cole, Vanduser, MO (US)

(21) Appl. No.: 12/910,021

(22) Filed: Oct. 22, 2010

Related U.S. Application Data
(60) Provisional application No. 61/254,594, filed on Oct. 23, 2009.

(51) Int. Cl. A01D 87/12; B66C 1/42

(52) U.S. Cl. 294/88; 294/106

(57) ABSTRACT

The grasping system is a farm implement used for moving bales. The grasping system has an upper rail assembly attached by a connecting assembly to a base. The upper rail assembly closes onto a bale and a spike strip pierces the bale and any covering. The bale is then moved and any covering is cut. The upper rail assembly is released from the bale by the connecting assembly.

### CROSS REFERENCE TO RELATED APPLICATIONS

This application claims the benefit of U.S. Provisional Application Ser. No. 61/254,594, filed by Cole on Oct. 23, 2009 and entitled “Grasping System”, which is incorporated herein by reference.

### FIELD OF INVENTION

The invention relates to equipment used for agricultural purposes.

### BACKGROUND OF THE INVENTION

Round cotton bale bagging machines have recently come to market and farmers are beginning to use these baggers to bag their cotton. These bags or round bales of cotton are heavy and difficult to move from the field or from the gin or other places. Many of the current movers have tines, which often pierce the bags.

Much of the equipment used in farm work needs to be simple with very few moving parts. When farm equipment has too many moving parts, the likelihood of any one part breaking increases. Then, crop harvesting and production ceases until the part is fixed. In agriculture, farms have a limited amount of time between harvesting and getting the product to the market that cannot be wasted on fixing machinery. Also, farm machinery with too many parts risk injury to farm laborers, including getting their clothing or body parts tangled into the device. Therefore, there is a need for equipment to move round bagged bales of material, such as cotton, using a simple product.

### SUMMARY OF THE INVENTION

The present disclosure is a bale moving device. The invention is an attachment that can be placed on a front loader or other farm equipment. The invention is a grasping assembly with an upper rail assembly comprising one or more rails in a semi-circular configuration with optional cross members. The upper rail assembly is attached to the lower base by an opening assembly comprising a hinge assembly and a hydraulic cylinder. The base has one or more rails with optional cross members and a second end perpendicular to the base with a protrusion.

### BRIEF DESCRIPTION OF DRAWINGS

FIG. 1 is a side view of the grasping assembly approaching a cotton bale according to the present invention.

FIG. 2 is a three-dimensional view of the grasping assembly according to the present invention.

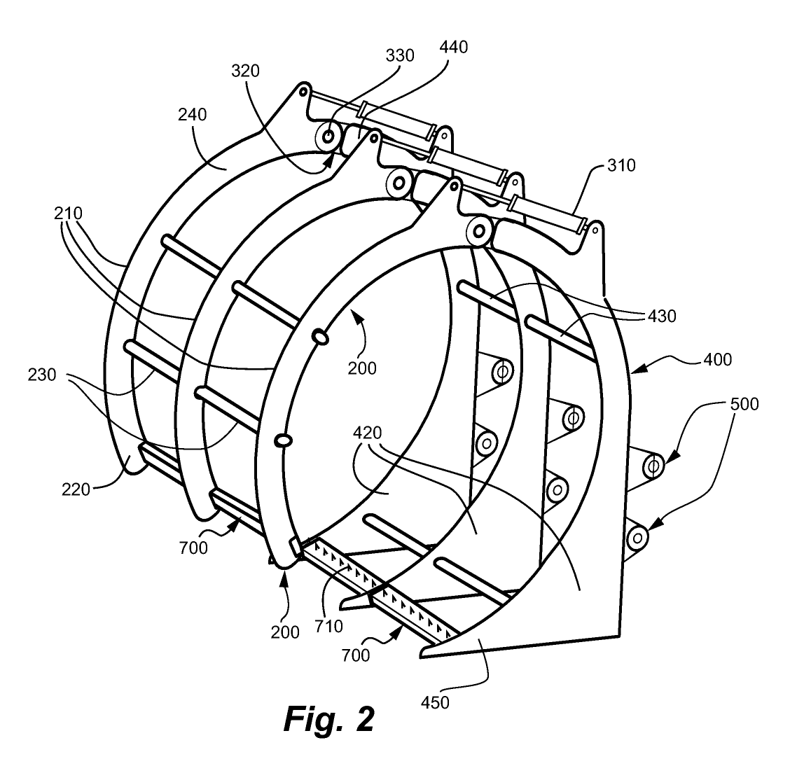

FIG. 3 is a side view of the spike plate according to the present invention.

FIG. 4 is a close-up view of the hinge assembly according to the present invention.

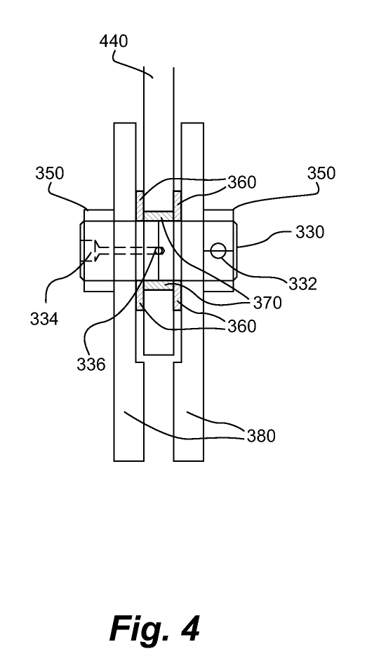

### DETAILED DESCRIPTION OF THE INVENTION

The present disclosure is a grasping assembly. The invention is an attachment that can be placed on a front loader, three-point hitch system, wheel loader, or other farm equipment.

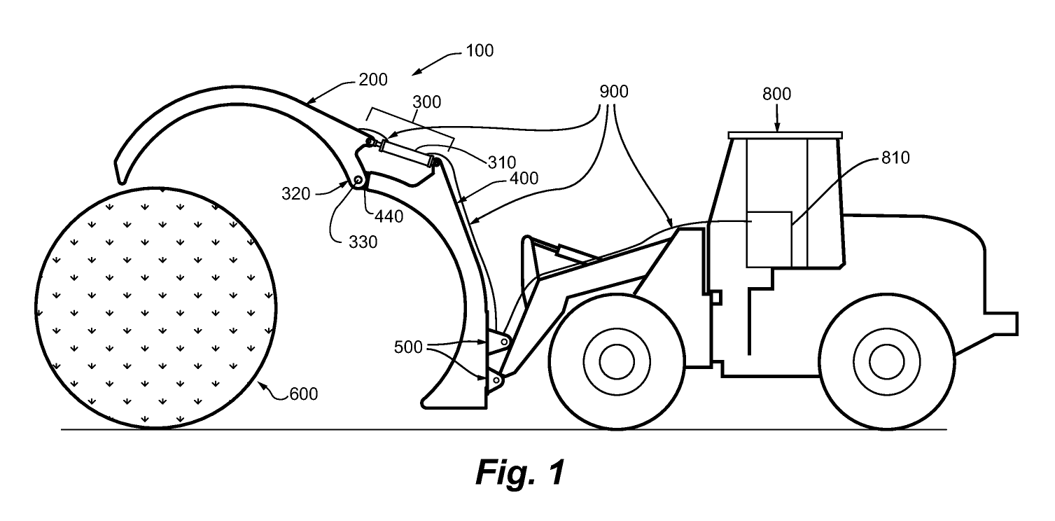

As shown in FIGS. 1 & 2, the invention is a grasping assembly 100 with an upper rail assembly 200 attached by an opening assembly 300 to the base 400. On the base is a connecting assembly 500. The invention is used to grasp and move any-sized covered bales 600.

The upper rail assembly 200 can be comprised of one of or more rails 210 with a distal end 220, which may be cross-member, and one or more interstitial cross-members 230. The proximal end 240 is attached to the opening assembly 300. The upper rail assembly 200 can be made of steel tubing, steel sheets, high density polymers, or other metals. The upper rail assembly 200 can be configured in a semi-circular or other arrangement near the covered bale 600 to correspond with the shape of the covered bale 600.

The opening assembly 300 can be comprised of a hinge assembly 320 and a hydraulic cylinder 310. The hydraulic cylinder 310 is placed on the first side, or the side closest to the farm implement, and the hinge assembly 320 is placed on the second side. The opening assembly 300 is used to move the distal end 220 closer or further away from the base 400.

The hinge assembly 320 can have hinge plates 380 welded to the first end 440 of the base 400 so as to position the upper rail assembly 200 laterally and rotationally in relationship with the first end 440 of the base 400. The hinge plates 380 are machined to allow for the insertion of replaceable low friction thrust bearing plates 360 to control lateral displacement of the upper rail assembly 200 and to eliminate the wear on the sides of the hinge plates 380 and the upper rail assembly 200. Each rail 210 has two hinge plates 380.

The rotation of the upper rail assembly 200 is determined by the orbit around the pin 330 inserted into the bore of the hinge plates 380. The pin 330 is fixed rotationally and axially by a collar arrangement 350 welded onto the hinge plate 380. The proximal end 240 is precision bored on the same axis as the bore in the hinge plate 380 for an interference fit with the outside diameter of a cylindrical low friction bearing plate 370. Inside diameter of this bearing plate 370 is such as to allow proper clearance for lubrication to be introduced through grease fitting passage 334 and grease exit 336 machined into the pin 330. The pin 330 can be attached to the collar 350 by a bolt 332.

The location of the pivot point of the upper rail assembly 200 is determined by the design and placement of the hinge plate 380 and pin 330. This allows the operator to approach the covered bale 600 with minimal vertical movement of the unit.

The base 400 has a lower rail assembly 410, including one or more rails 420 with optional cross-members 430. The second end 450 is a protrusion that is mostly perpendicular to the base 400. The second end 450 may have end in either in one or more rails 420 or a spike plate 700 with one or more spikes 710.

The limit of rotation of the upper rail assembly 200 is determined by the overall stroke length of the base 400 and by pivot points and by where hydraulic cylinder 310 is connected to the upper rail assembly 200 and the base 400. Hydraulic cylinder 310 diameter and the length of the base 400 can be varied to accommodate any variations in future covered bale 600 configurations regarding diameter or weights. The base 400 is of sufficient length to allow the closure of the upper rail assembly 200 on covered bales 600 of any size.

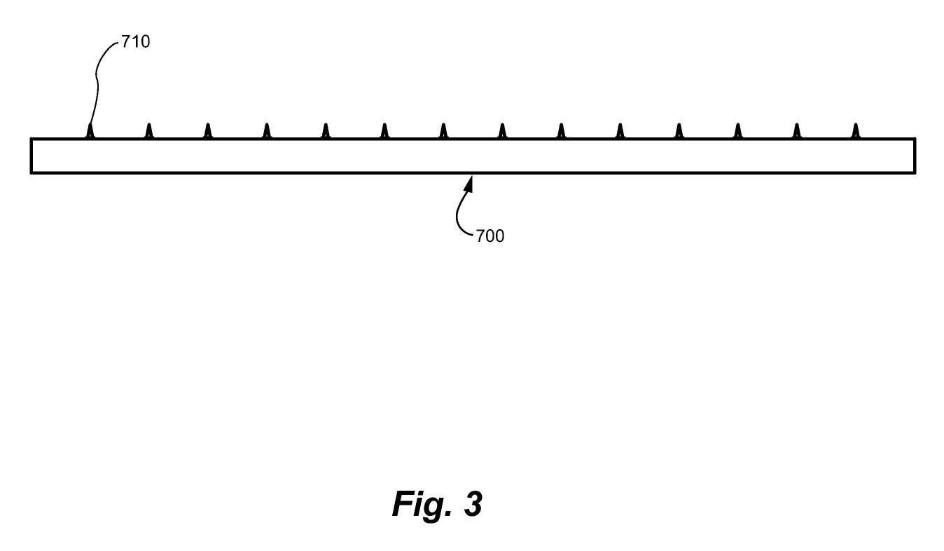

FIG. 3 is a spike strip 700 with one of more spikes 710. The spike strip 700 can be attached on the distal end 450 of the base 400 and can also be attached to the distal end 220 of the upper rail assembly 200. The spikes 710 on the spike strip 700 pierce any covered bale 600. The covered bale 600 is cut by hand and the spikes 710 remain embedded in the cover releasing it from the covered bale 600.

The front loader 800 is attached by the connecting assembly 500 to the grasping system 100. The upper rail assembly 200 has one or more lines 900 connecting it to the hydraulic cylinder 310 and the actuator 810 or controls in the front loader 800. The actuator 810 controls the upper rail assembly 200 using the opening assembly 300.

What is claimed is:

1. A grasping apparatus comprising an upper rail assembly with an opening assembly, having a hinge assembly and at least one hydraulic cylinder, attached to the proximal end of an upper rail assembly and attached to the first end of a base having a second end with a protrusion perpendicular to the base.

2. The apparatus according to claim 1 wherein the upper rail assembly comprises one or more rails.

3. The apparatus according to claim 1 wherein the base comprises one or more rails.

4. The apparatus according to claim 1 wherein second end of the base has a plate attached.

5. The apparatus according to claim 1 wherein the upper rail assembly has one or more cross members.

6. The apparatus according to claim 1 wherein the opening assembly consists of hydraulic cylinder on the first side of the base and upper rail assembly and a hinge assembly on the second side of the base and upper rail assembly.

7. The apparatus according to claim 1 wherein the hinge assembly comprises hinge plates inserted into the base to allow replaceable bearing plates to be inserted onto the hinge plates and a pin and collar arrangement are welded onto the hinge plate.

8. The apparatus according to claim 1 wherein one or more spike strips are attached to the base or the upper rail assembly

9. A system for grasping comprising an upper rail assembly with an opening assembly, having a hinge assembly and at least one hydraulic cylinder, attached to the proximal end of an upper rail assembly and attached to the first end of a base having a second end with a protrusion perpendicular to the base.

9. The system according to claim 8 wherein the upper rail assembly comprises one or more rails.

10. The system according to claim 8 wherein the base comprises one or more rails.

11. The system according to claim 8 wherein second end of the base has a plate attached.

12. The system according to claim 8 wherein the upper rail assembly has one or more cross members.

13. The system according to claim 8 wherein the opening assembly consists of hydraulic cylinder on the first side of the base and upper rail assembly and a hinge assembly on the second side of the base and upper rail assembly.

14. The system according to claim 8 wherein the hinge assembly comprises hinge plates inserted onto the base to allow replaceable bearing plates to be inserted into the hinge plates and a pin and collar arrangement are welded onto the hinge plate.

15. A method of grasping bales comprising an upper rail assembly with an opening assembly, having a hinge assembly and at least one hydraulic cylinder, attached to the proximal end of an upper rail assembly and attached to the first end of a base having a second end with a protrusion perpendicular to the base.

16. The method in claim 15 wherein the upper rail assembly closes when a bale touches the base.
